(19) United States
(12) Patent Application Publication
(10) Pub. No.: US 2010/0053409 A1
(43) Pub. Date: Mar. 4, 2010

(54) ELECTRONIC DEVICE

(76) Inventor: Hu-Sung Chang, Taipei (TW)

Correspondence Address: Muncy, Geissler, Olds & Lowe, PLLC, P.O. BOX 1364, FAIRFAX, VA, 22038-1364, US

(21) Appl. No.: 12/548,068

(22) Filed: Aug. 26, 2009

(30) Foreign Application Priority Data
Aug. 27, 2008 (TW) 097132704

(51) Int. Cl. H04N 5/222

(52) U.S. Cl. 348/333.01; 348/E05.022

(57) ABSTRACT

An electronic device includes a casing, an image capturing module, and a biaxial hinge element. The biaxial hinge element has a first hinge and a second hinge. Two ends of the first hinge protrude from two sides of the biaxial hinge element thus to be pivotally connected to the casing, respectively. The second hinge is pivotally connected to the image capturing module.

### CROSS REFERENCE TO RELATED APPLICATIONS

This Non-provisional application claims priority under 35 U.S.C. §119(a) on Patent Application No(s). 097132704 filed in Taiwan, Republic of China on Aug. 27, 2008, the entire contents of which are hereby incorporated by reference.

### BACKGROUND OF THE INVENTION

1. Field of Invention

The invention relates to an electronic device and, more particularly, to an electronic device capable of capturing images.

2. Related Art

As the popularity of network communication, current electronic devices such as a notebook, a desktop, and a portable communication device can provide a multimedia function of image input/output. To satisfy needs in different cases such as video conferences or instant messaging systems, the electronic device with an image capturing module has to be provided.

Please refer to FIG. 1A. A conventional notebook 1 includes a display 11, a main body 12, and a camera 13. The display 11 includes a display panel 111 and a casing 112. The display panel 111 is contained in the casing 112. The main body 12 includes a keyboard 121 used as an input device. The camera 13 used as an image input device is embedded in the center of the top portion of the display panel 111, and it is pivotally connected to the casing 112.

In FIG. 1B, the camera 13 is pivotally connected to the casing 112, thus the camera 13 can rotate in a direction T1 to capture images. However, the camera 13 is connected to the casing 112 via a single-axial hinge, and the camera 13 only rotates along the single axis. For example, the camera 13 only rotate upward or downward in the direction T1, so not all images at any location can be captured. For example, images of great viewpoints on the left and right sides of the camera 13 may fail to be captured.

### SUMMARY OF THE INVENTION

The invention provides an electronic device having an image capturing module capable of rotating in a plurality of axial directions to improve the prior art.

According to one aspect of the invention, an electronic device includes a casing, an image capturing module, and a biaxial hinge element. The biaxial hinge element has a first hinge and a second hinge. Two ends of the first hinge protrude from two sides of the biaxial hinge element thus to be pivotally connected to the casing, respectively. The second hinge is pivotally connected to the image capturing module.

In one embodiment of the invention, the first hinge and the second hinge may be perpendicular to each other.

In one embodiment of the invention, the two ends of the first hinge may have a pivot portion respectively, and the second hinge may have at least one pivot portion.

In one embodiment of the invention, the biaxial hinge element may include a cross universal joint or a T-shaped universal joint.

In one embodiment of the invention, the casing may have at least one recess for containing the biaxial hinge element and/or image capturing module.

In one embodiment of the invention, the casing may include a sliding mechanism disposed at the recess and pivotally connected with the first hinge.

To sum up, the electronic device according to the invention has a biaxial hinge element. Two ends of the first hinge protrude from two sides of the biaxial hinge element thus to be pivotally connected to the casing, respectively, and the second hinge is pivotally connected to the image capturing module, thus allowing the image capturing module to be capable of rotating in a plurality of axial directions. Therefore, multi-viewpoint images (including images in front of and at the back of the displaying surface of the electronic device) can be captured, thus greatly enlarging the capturing scope of the image capturing module.

These and other features, aspects, and advantages of the present invention will become better understood with regard to the following description, appended claims, and accompanying drawings.

### BRIEF DESCRIPTION OF THE DRAWINGS

FIG. 1A is a schematic diagram of a conventional notebook;

FIG. 1B is a schematic diagram showing rotation of a camera of the notebook in FIG. 1A;

FIG. 2A is a schematic diagram of an electronic device according to a first embodiment of the invention;

FIG. 2B is an enlarged partial schematic diagram of the electronic device according to the first embodiment of the invention;

FIG. 2C is a schematic diagram of a biaxial hinge element in FIG. 2B;

FIG. 2D and FIG. 2E are schematic diagrams showing operation of an image capturing module and a biaxial hinge element of the electronic device according to the first embodiment of the invention;

FIG. 3A is a schematic diagram of an electronic device according to a second embodiment of the invention;

FIG. 3B is an enlarged partial schematic diagram of the electronic device according to the second embodiment of the invention;

FIG. 3C and FIG. 3D are schematic diagrams showing operation of an image capturing module and a biaxial hinge element of the electronic device according to the second embodiment of the invention;

FIG. 4A is a schematic diagram of an electronic device according to a third embodiment of the invention;

FIG. 4B is an enlarged partial schematic diagram of the electronic device according to the third embodiment of the invention; and

FIGS. 4C-4E are schematic diagrams showing operation of an image capturing module and a biaxial hinge element of the electronic device according to the third embodiment of the invention.

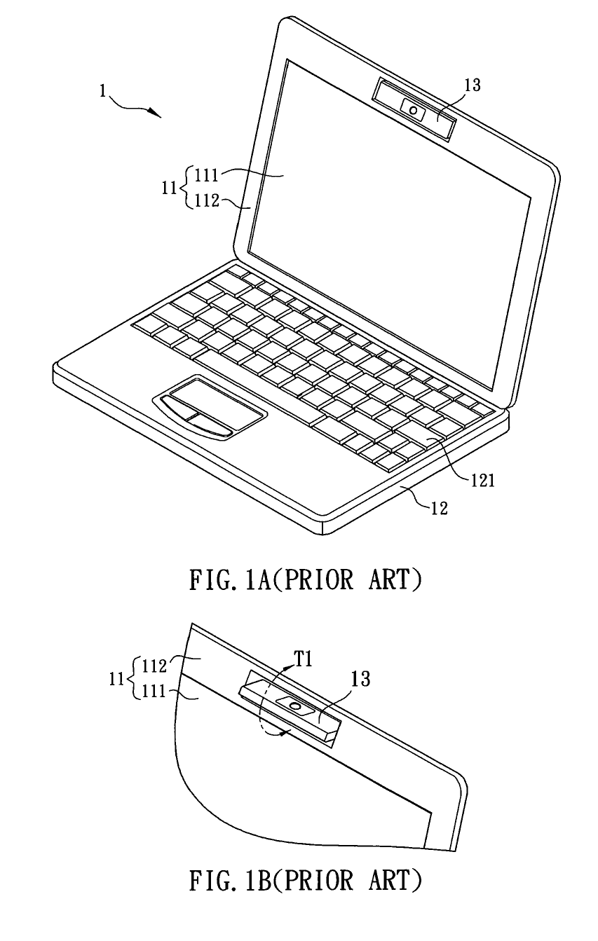

### DETAILED DESCRIPTION OF THE INVENTION

### A First Embodiment

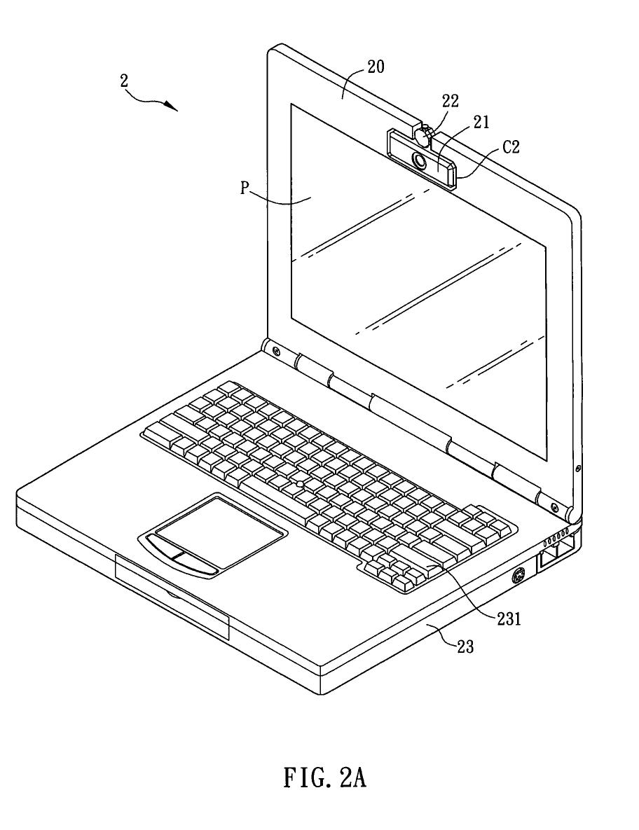

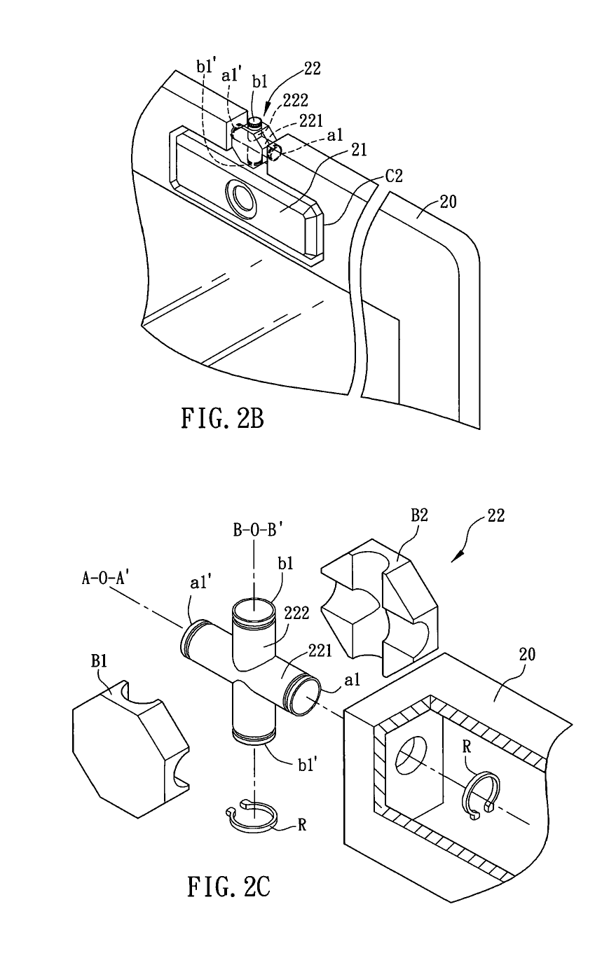

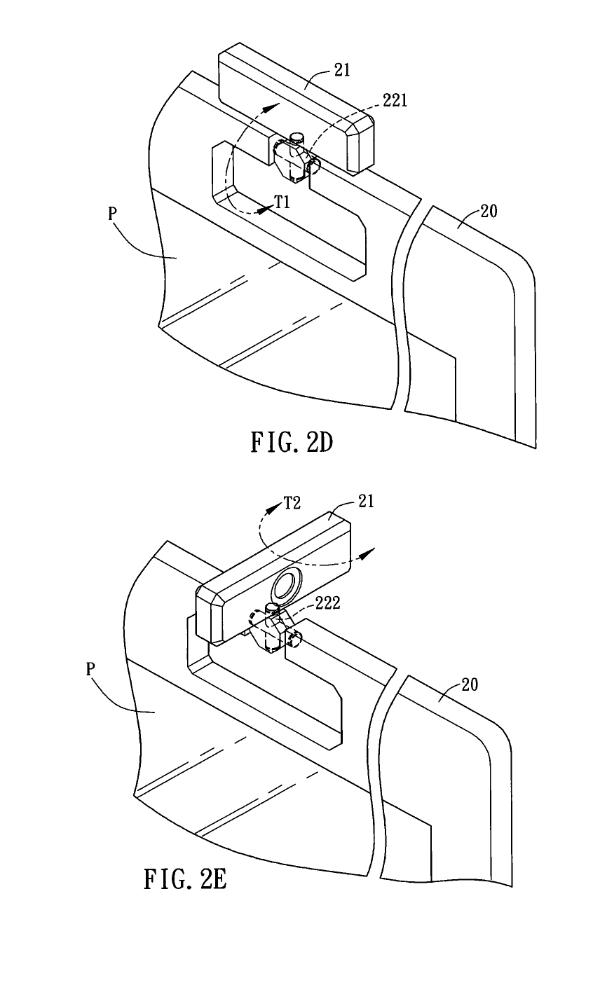

Please refer to FIG. 2A. An electronic device 2 according to the first embodiment of the invention may be a notebook, a desktop, a communication device, a flat panel display device, or other electronic device having an image capturing module.

The electronic device 2 in this embodiment may be a notebook including a casing 20, an image capturing module 21, and a biaxial hinge element 22. In this embodiment, the casing 20 is an outer casing containing a display panel P. The image capturing module 21 can include a charge coupled device (CCD), a complementary metal oxide semiconductor (CMOS), or other opto-electronic element capable of converting light into electrical signals to form images. Further, the electronic device 2 can further include a main body 23 having a keyboard 231 used as an input device.

FIG. 2B is an enlarged partial schematic diagram showing the image capturing module 21. In FIG. 2B, the biaxial hinge element 22 has a first hinge 221 and a second hinge 222. The first hinge 221 and the second hinge 222 are connected with each other. Two ends of the first hinge 221 protrude from two sides of the biaxial hinge element 22 thus to be pivotally connected to the casing 20 respectively, forming a first axis (of rotation). The second hinge 222 is pivotally connected to the image capturing module 21. The image capturing module 21 can rotate along the first axis and the second axis. Therefore, the image capturing module 21 can rotate in a plurality of axial directions.

Further, the casing 20 has at least one recess C2 for containing the biaxial hinge element 22 and/or the image capturing module 21. The recess C2 in this embodiment is a through hole and is disposed in the center of the casing 20, thus containing the biaxial hinge element 22 and the image capturing module 21.

The biaxial hinge element 22 may be further described hereinbelow. In FIG. 2C, the first hinge 221 and the second hinge 222 of the biaxial hinge element 22 in this embodiment are perpendicular to each other, and they are integrally formed. The first hinge 221 has two pivot portions a1, a1′ disposed at the two ends of the first hinge 221 and protruding from the two sides of the biaxial hinge element 22. Further, the two pivot portions a1, a1′ are disposed at a first axis A-O-A′. The second hinge 222 has at least one pivot portion. In this embodiment, two pivot portions b1, b1′ are taken for example, and they are disposed at a second axis B-O-B′. The biaxial hinge element 22 can include a cross universal joint or a T-shaped universal joint. In this embodiment, the biaxial hinge element 22 is a cross universal joint formed by the first hinge 221 and the second hinge 222. The biaxial hinge element 22 in this embodiment further includes two covers B1, B2 connected with each other and covering at least one portion of the first hinge 221 and the second hinge 222.

In FIG. 2B and FIG. 2C, the pivot portions a1, a1′ of the first hinge 221 protruding from the two sides of the biaxial hinge element 22 are pivotally connected to the casing 20. Further, the second hinge 222 has at least one pivot portion pivotally connected to the image capturing module 21. In this embodiment, the pivot portion b1′ is pivotally connected to the image capturing module 21. The biaxial hinge element 22 further includes at least one C-shaped ring R disposed around the first hinge 221 and/or the second hinge 222 and pressing the casing 20 and/or the image capturing module 21, respectively. In this embodiment, the biaxial hinge element 22 has a plurality of C-shaped rings R disposed around the pivot portion a1, a1′ of the first hinge 221 and pressing the casing 20 and disposed around the pivot portion b1′ of the second hinge 222 and pressing the image capturing module 21, respectively.

The operation of the image capturing module 21 via the biaxial hinge element 22 in this embodiment is described as follows. In FIG. 2D, the image capturing module 21 can rotate in a direction T1 via the first hinge 221 to capture images at the back of the display panel P; in FIG. 2E, the image capturing module 21 can rotate in another direction T2 via the second hinge 222 to capture images in front of the display panel P. Of course, multi-viewpoint images including the images in the up, down, left, and right directions in front of and/or at the back of the display panel P can be captured via the first hinge 221 and the second hinge 222.

### A Second Embodiment

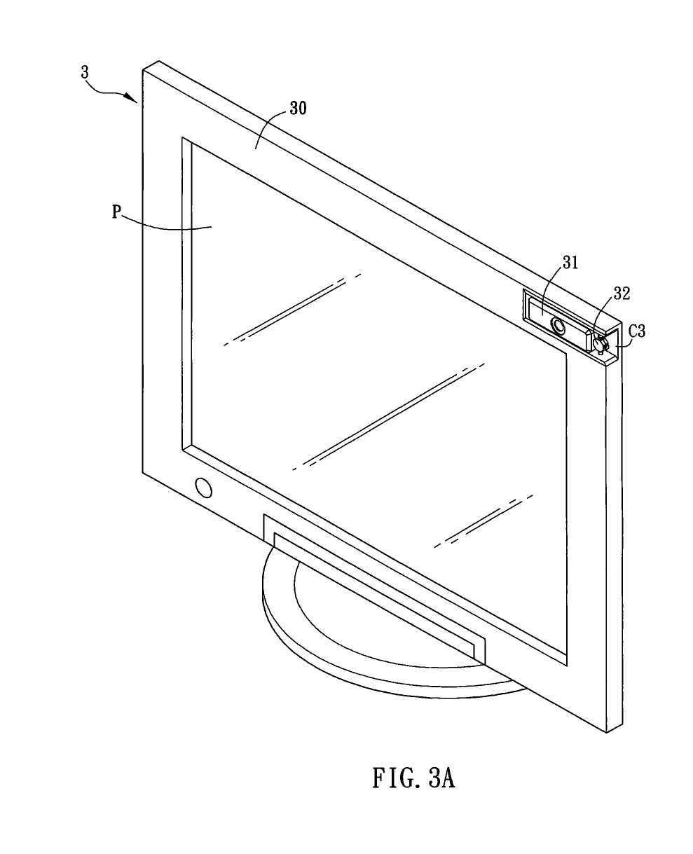

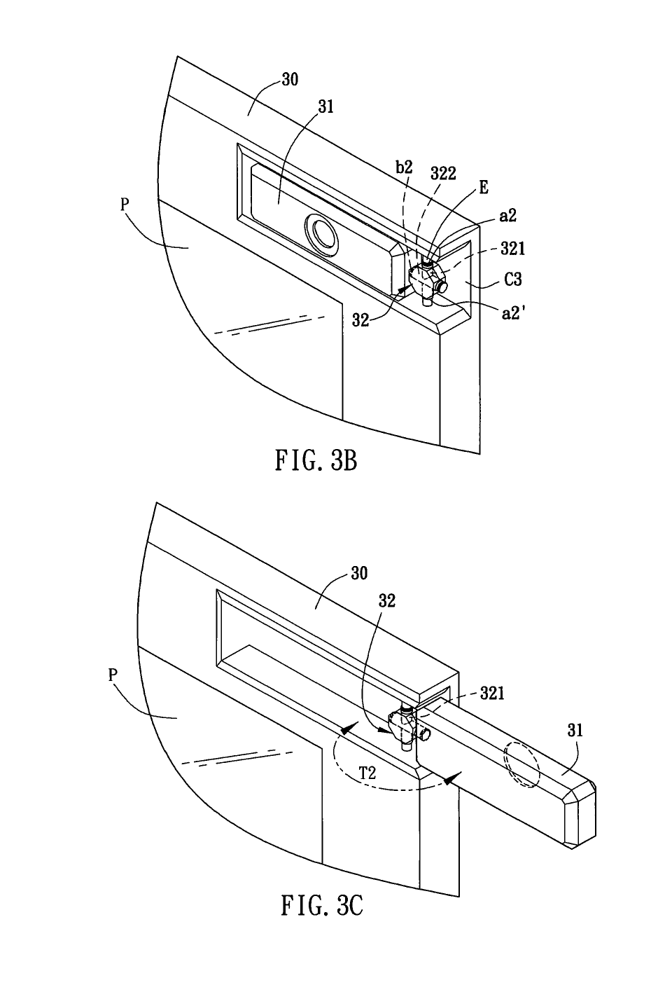

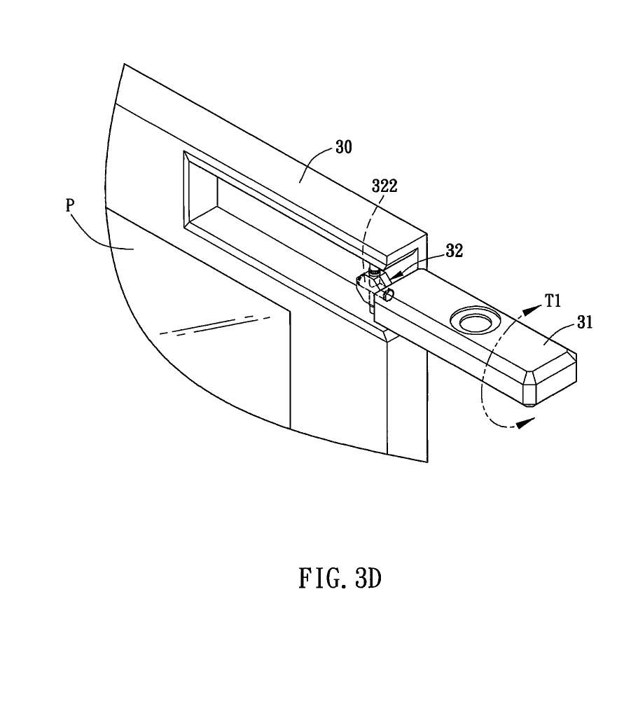

Please refer to FIG. 3A. An electronic device 3 according to the second embodiment of the invention includes a casing 30, an image capturing module 31, and a biaxial hinge element 32. The electronic device 3 in this embodiment may be a flat panel display device such as a liquid crystal display (LCD). In this embodiment, the casing 30 is an outer frame containing a flat display panel P and has a recess C3 disposed at one corner of the casing 30 for containing the image capturing module 31 and the biaxial hinge element 32.

In FIG. 3B, in this embodiment, two ends of a first hinge 321 of the biaxial hinge element 32 are pivotally connected to the casing 30. The casing 30 has an arm portion E disposed on an outer side of the recess C3, and two pivot portions a2, a2′ of the first hinge 321 are pivotally connected to the arm portion E. A second hinge 322 is pivotally connected to one side of the image capturing module 31 via pivotally connecting a pivot portion b2 and the image capturing module 31. The structure of the biaxial hinge element 32 is the same as the biaxial hinge element 22 in the first embodiment, and therefore it is not described for concise.

Please refer to FIG. 3C and FIG. 3D. The operation of the image capturing module 31 via the biaxial hinge element 32 in this embodiment is described as follows. In FIG. 3C, the image capturing module 31 can rotate in a direction T2 via the first hinge 321 to capture images at the back of the display panel P; in FIG. 3D, the image capturing module 31 can rotate in another direction T1 via the second hinge 322 to capture images in front of the display panel P. Of course, multi-viewpoint images including the images in the up, down, left, and right directions in front of and/or at the back of the display panel P can be captured via the first hinge 321 and the second hinge 322.

### A Third Embodiment

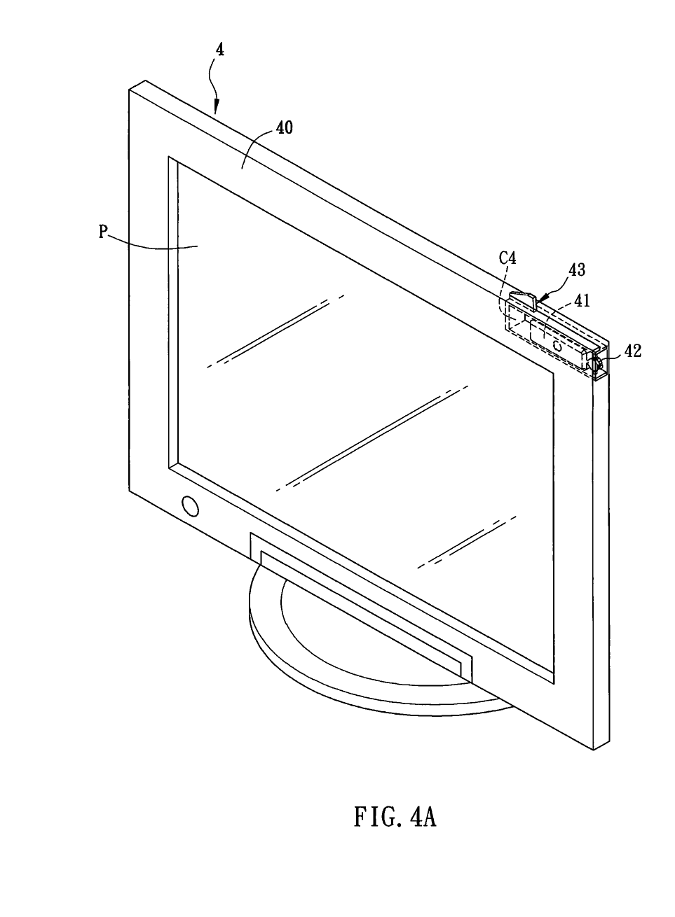

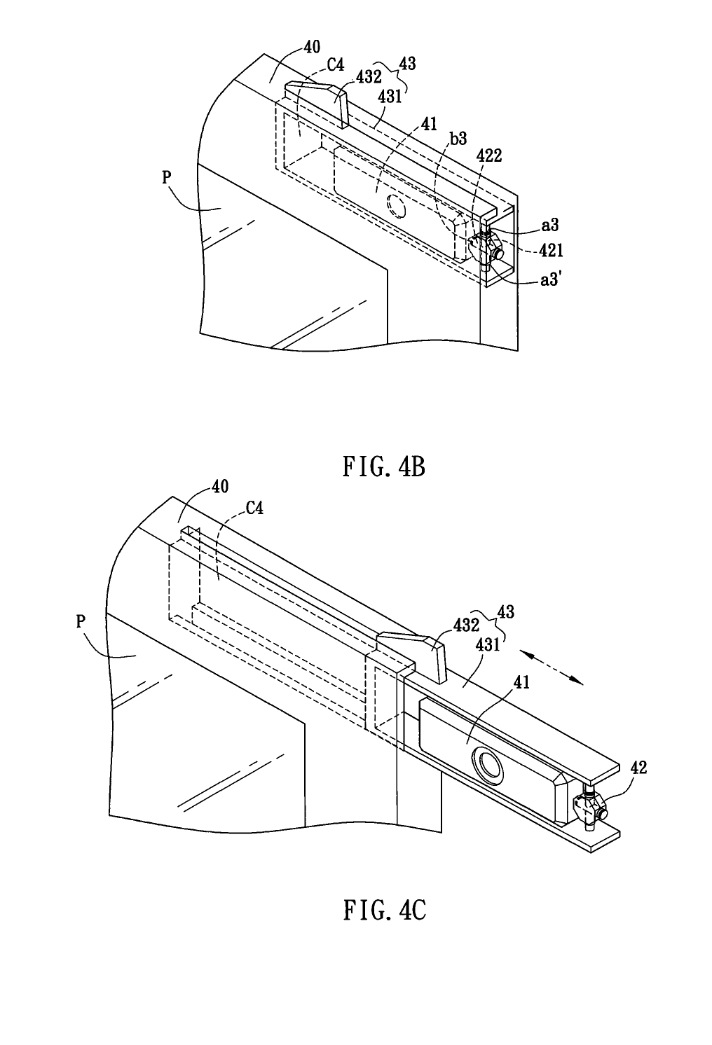

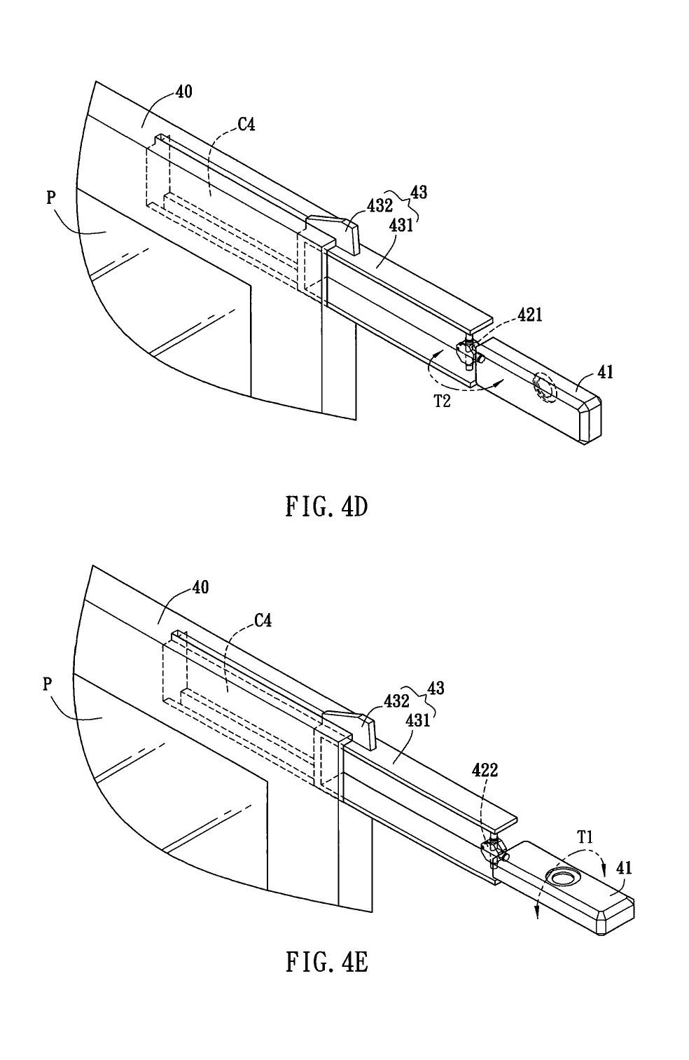

Please refer to FIG. 4A. An electronic device 4 according to the third embodiment includes a casing 40, an image capturing module 41, and a biaxial hinge element 42. Similarly, the electronic device 4 in this embodiment may be flat panel display device. The casing 40 in this embodiment is an outer frame containing a flat display panel P. In this embodiment, the image capturing module 41 and the biaxial hinge element 42 are disposed at one corner of the casing 40. The casing 40 has a recess C4 such as a sliding track for containing the image capturing module 41 and the biaxial hinge element 42. The casing 40 further includes a sliding mechanism 43 pivotally connected with two ends of a first hinge of the biaxial hinge element 42.

Please refer to FIG. 4B. The sliding mechanism 43 is disposed at the recess C4 and has a sliding frame 431 and a fastening portion 432. The sliding frame 431 is slidingly disposed at the recess C4, and the fastening portion 432 is fastened to the recess C4. The sliding mechanism 43 is pivotally connected to the first hinge 421. In this embodiment, two pivot portions a3, a3′ of the first hinge 421 are pivotally connected with the sliding frame 431 of the sliding mechanism 43. A second hinge 422 is pivotally connected with the image capturing module 41 via pivotally connecting a pivot portion b3 and the image capturing module 41. The structure of the biaxial hinge element 42 is the same as the biaxial hinge element 22 in the first embodiment, and therefore it is not described for concise.

Please refer to FIGS. 4C-4E. The operation of the image capturing module 41 via the sliding mechanism 43 and the biaxial hinge element 42 in this embodiment is described as follows. In FIG. 4C, the sliding mechanism 43 can be slid out of or into the recess C4 (arrows in the figure indicates the moving direction). When the sliding mechanism 43 is slid out, capturing scope can be enlarged; when the sliding mechanism 43 is slid in, the image capturing module 41 can be hidden. In FIG. 4D, the image capturing module 41 can rotate in a direction T2 via the first hinge 421 to capture images at the back of the display panel P; in FIG. 4E, the image capturing module 41 can rotate in another direction T1 via the second hinge 422 to capture images in front of the display panel P. Of course, multi-viewpoint images including the images in the up, down, left, and right directions in front of and/or at the back of the display panel P can be captured via the sliding mechanism 43, the first hinge 421, and the second hinge 422.

To sum up, the electronic device in the invention has a biaxial hinge element. Two ends of the first hinge protrude from two sides of the biaxial hinge element thus to be pivotally connected to the casing respectively, and the second hinge is pivotally connected to the image capturing module, thus allowing the image capturing module to be capable of rotating in a plurality of axial directions. Therefore, multi-viewpoint images (including images in front of and at the back of the displaying surface of the electronic device) can be captured, thus greatly enlarging the capturing scope of the image capturing module.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device comprising:
a casing;
an image capturing module; and
a biaxial hinge element having a first hinge and a second hinge, two ends of the first hinge protruding from two sides of the biaxial hinge element to be pivotally connected to the casing, the second hinge pivotally connected to the image capturing module.

2. The electronic device according to claim 1, wherein the first hinge and the second hinge are perpendicular to each other.

3. The electronic device according to claim 1, wherein the two ends of the first hinge have a pivot portion respectively, and the second hinge has at least one pivot portion.

4. The electronic device according to claim 1, wherein the biaxial hinge element comprises a cross universal joint or a T-shaped universal joint.

5. The electronic device according to claim 1, wherein the biaxial hinge element further comprises two covers connected with each other and covering at least one portion of the first hinge and the second hinge.

6. The electronic device according to claim 1, wherein the biaxial hinge element further comprises at least one C-shaped ring disposed around the first hinge or the second hinge and pushing the casing or the image capturing module, respectively.

7. The electronic device according to claim 1, wherein the casing has at least one recess for containing the biaxial hinge element or the image capturing module.

8. The electronic device according to claim 7, wherein the casing has an arm portion disposed on an outer side of the recess, and the first hinge is pivotally connected with the arm portion.

9. The electronic device according to claim 7, wherein the casing comprises a sliding mechanism disposed at the recess and pivotally connected with the first hinge.

10. The electronic device according to claim 9, wherein the sliding mechanism has a sliding frame and a fastening portion, the sliding frame is slidingly disposed at the recess, and the fastening portion is fastened to the recess.

11. The electronic device according to claim 1, wherein the image capturing module and the biaxial hinge element are disposed at one corner of the casing.

12. The electronic device according to claim 1, wherein the image capturing module comprises a charge coupled device or a complementary metal oxide semiconductor.

13. The electronic device according to claim 1, wherein the electronic device may be a notebook, a desktop, a portable communication device, or a flat panel display device.
